(19) United States
(12) Patent Application Publication
(10) Pub. No.: US 2015/0158366 A1
(43) Pub. Date: Jun. 11, 2015

(54) SYSTEM AND METHOD OF CONTROLLING HEATER OF ENVIRONMENTALLY-FRIENDLY VEHICLE

(71) Applicant: Hyundai Motor Company, Seoul (KR)

(72) Inventor: Jaehyuk LEE, Suwon-Si (KR)

(21) Appl. No.: 14/333,055

(22) Filed: Jul. 16, 2014

(30) Foreign Application Priority Data
Dec. 10, 2013 (KR) 10-2013-0153473

(51) Int. Cl. B60H 1/00

(52) U.S. Cl. CPC B60H 1/00642

(57) ABSTRACT

A system for controlling a heater of an environmentally-friendly vehicle includes a signal input configured to input a heating demand. A positive temperature coefficient (PTC) heater is a heat source for heating. A controller is configured to determine a target temperature according to the heating demand, determine the quantity of power supplied to the PTC heater, and determine a duty cycle of a pulse width modulation (PWM) signal. A switch is controlled according to a PWM signal of the controller to operate the PTC heater. A charger is charged/discharged when the switch is turned on/off according to the PWM signal of the controller to protect the PTC heater.

### CROSS-REFERENCE TO RELATED APPLICATION

The present application claims the benefit of priority to Korean Patent Application Number 10-2013-0153473 filed on Dec. 10, 2013, the entire contents of which application are incorporated herein for all purposes by this reference.

### TECHNICAL FIELD

The present disclosure relates to a system and a method of controlling a heater of an environmentally-friendly vehicle, and more particularly, to a system and a method of controlling a heater of an environmentally-friendly vehicle, which may more stably control a positive temperature coefficient (PTC) heater by applying a pulse width modulation (PWM) method, and minimize power loss.

### BACKGROUND

Various types of environmentally-friendly vehicles, including a hybrid vehicle, a pure electric vehicle, a fuel cell vehicle, and a plug-in hybrid electric vehicle, have been developed and operated according to a demand to improve fuel efficiency and enhancement of exhaust gas regulations.

The environmentally-friendly vehicle includes a battery storing a high voltage, and drives a motor with the high voltage stored in the battery to be traveled.

In order to provide a passenger with a pleasant indoor environment and secure stable visibility, a technology of operating a positive temperature coefficient (PTC) heater by using a high voltage of about 250 to 300 V or more stored in the battery to heat the indoor is applied to the environmentally-friendly vehicle.

The quantity of heat of the PTC heater is generally controlled by a method of directly controlling a high voltage by using a pulse width modulation (PWM) signal illustrated in FIG. 4.

In order to control the quantity of heat of the PTC heater, a micom, which is not illustrated, outputs the PWM signal illustrated in FIG. 4 under a set frequency condition, turns on/off a semiconductor switching device, such as a field effect transistor (FET), a metal oxide semiconductor field effect transistor (MOSFET), and an insulated gate bipolar transistor (IGBT) and controls the high voltage of the battery supplied to the PTC heater.

Accordingly, there is a problem in that heat is generated by the repeated on/off operation of the semiconductor switch device, thereby burning the semiconductor switching device.

Further, since an unnecessary voltage is supplied when the PTC heater is heated by adjusting the voltage supplied to the PTC heater due to the repeated on/off operation of the semiconductor switching device, power loss is generated, thereby decreasing a travel distance by the high-voltage battery.

Further, noise may be generated according to setting of the PWM frequency, so that there is a disadvantage in that a frequency having a set value or more need to be used.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a system and a method of controlling a heater of an environmentally-friendly vehicle, which stabilize power supplied to a PTC heater and minimize power loss by further including a charging circuit in a high-voltage power line.

According to an exemplary embodiment of the present disclosure, a system for controlling a heater of an environmentally-friendly vehicle includes a signal input configured to input a heating demand and a temperature setting signal of a driver. A positive temperature coefficient (PTC) heater is a heat source for heating. A controller is configured to determine a target temperature according to the heating demand and the temperature setting, determine a quantity of power supplied to the FTC heater, and determine a duty cycle of a pulse width modulation (PWM) signal according to the target temperature. A switch switches according to the PWM signal of the controller to operate the PTC heater. A charger is configured to charge/discharge when the switch is turned on/off according to the PWM signal of the controller to protect the PTC heater.

The PTC heater and the charger may be connected to a high-voltage power line in parallel.

The controller may determine a quantity of charge of the charger according to the quantity of power supplied to the PTC heater and control the charge of the charger.

The controller may variably set the quantity of charge of the charger according to the target temperature and the quantity of heat of the PTC heater, and the quantity of power supplied to the PTC heater.

The charger may be charged with a high-voltage power source of a battery supplied to the PTC heater when the switch is turned on according to a control signal of the controller, and supply the charged voltage to the PTC heater when the switch is turned off, and the high-voltage power source of the battery supplied to the PTC heater is blocked.

When the switch is turned on, the charger may block supply of an overvoltage to the PTC heater to prevent heat from being lost.

According to another exemplary embodiment of the present disclosure, a method of controlling a heater of an environmentally-friendly vehicle includes determining a target temperature of a positive temperature coefficient (PTC) heater when a heating demand of a driver is detected. A quantity of power supplied to the PTC heater is calculated according to the target temperature. A duty cycle of a pulse width modulation (PWM) signal is determined according to the quantity of power supplied to the PTC heater. A quantity of charge charged in a charger is determined, which is connected to the PTC heater in parallel, according to the quantity of power supplied to the PTC heater. The PTC heater is operated by controlling turning on/off a switch in response to an output of the PWM signal, and by controlling charge/discharge of the charger, which is connected to the PTC heater in parallel.

When the switch is turned on with the output of the PWM signal, the charger may be charged with a power source supplied to the PTC heater to prevent an overvoltage from being supplied to the PTC heater.

When the switch is turned off with the output of the PWM signal, a voltage charged in the charger may be supplied to the PTC heater to maintain an operation of the PTC heater even in a state where a high-voltage power source is blocked.

According to the exemplary embodiments of the present disclosure, it is possible to control an average voltage of the PWM signal, which controls the switch in order to heat the PTC heater to be higher than that of a PWM signal in the related art, thereby providing an equal or higher effect even at a low frequency.

The present disclosure uses a low frequency for controlling the switch, so that noise is minimally generated, thereby providing stable switching.

The present disclosure may store a voltage unnecessarily supplied to the PTC heater in an on-operation of the switch in the charging circuit and heat the PTC heater with the voltage stored in the charging circuit in an off-operation of the switch, thereby minimizing power consumption.

### BRIEF DESCRIPTION OF THE DRAWINGS

FIG. 1 is a diagram schematically illustrating a system for controlling a heater of an environmentally-friendly vehicle according to an exemplary embodiment of the present disclosure.

FIG. 2 is a diagram schematically illustrating a procedure for controlling a heater of an environmentally-friendly vehicle according to an exemplary embodiment of the present disclosure.

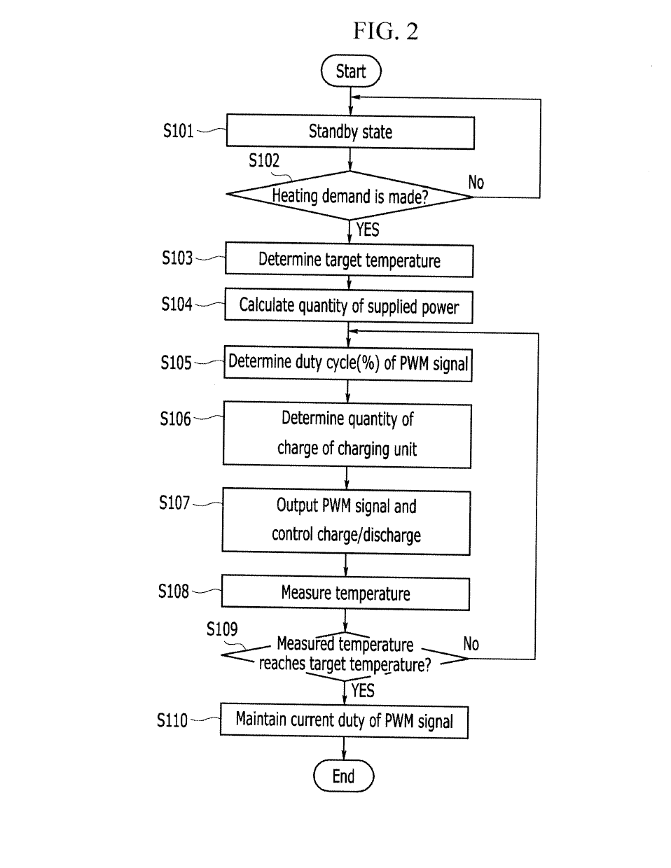

FIG. 3 is a diagram illustrating a heater control PWM signal of an environmentally-friendly vehicle according to an exemplary embodiment of the present disclosure.

FIG. 4 is a diagram illustrating a heater control PWM signal of an environmentally-friendly vehicle in the related art.

### DETAILED DESCRIPTIONS

The present disclosure will be described more fully hereinafter with reference to the accompanying drawings, in which exemplary embodiments of the inventive concept are shown.

As those skilled in the art would realize, the described embodiments may be modified in various different ways, all without departing from the spirit or scope of the present disclosure.

A part irrelevant to the description will be omitted to clearly describe the present disclosure, and the same elements will be designated by the same reference numerals throughout the specification.

In addition, each configuration illustrated in the drawings is arbitrarily shown for convenience of a description, but the present disclosure is not limited thereto.

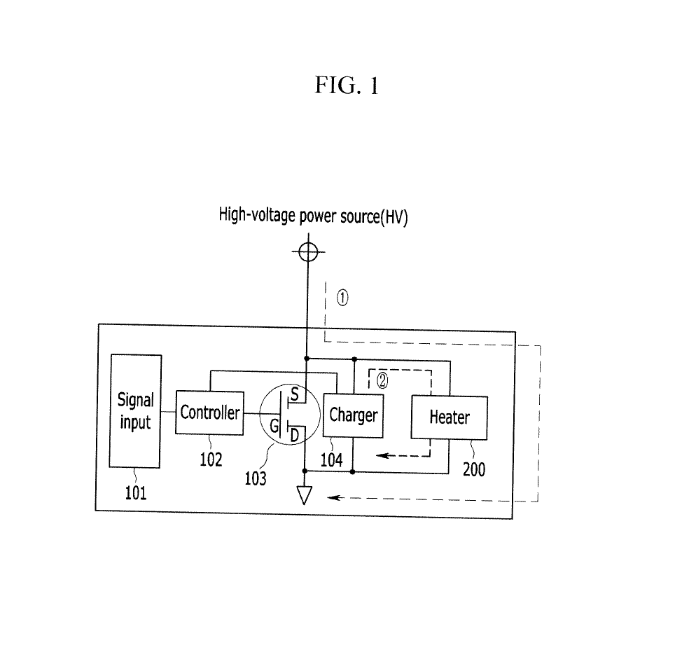

FIG. 1 is a diagram schematically illustrating a system for controlling a heater of an environmentally-friendly vehicle according to an exemplary embodiment of the present disclosure. Referring to FIG. 1, the system according to the present disclosure includes a signal input 101, a controller 102, a switch 103, a charger 104, and a positive temperature coefficient (PTC) heater 200.

The signal input 101 detects a heating demand and a setting temperature selected by a driver and provides the controller 102 with information on the detected heating demand and setting temperature.

The controller 102 determines a target temperature for heating the PTC heater 200 according to the heating demand and the setting temperature applied from the signal input 101, calculates a quantity of power supplied to the PTC heater 200 according to the determined target temperature, and determines a duty cycle (%) of a pulse width modulation (PWM) signal.

The controller 102 may variably set a quantity of charge of the charger 104 according to the determined target temperature determined by the setting temperature, the quantity of power supplied to the PTC heater 200, and a temperature of the heat emitted from the PTC heater 200.

When the duty cycle (%) of the PWM signal is determined, the controller 102 turns on/off the switch 103 with an output of the PWM signal and supplies a high-voltage power source HV of the battery to the PTC heater 200 for the PTC heater 200 to emit heat.

When the controller 102 controls on/off of the switch 103 by outputting the PWM signal, the controller 102 controls a charging operation of the charger 104 in an on-operation of the switch 103, in which the high-voltage power source HV of the battery is supplied to the PTC heater 200. The controller 102 then outputs a voltage charged in the charger 104 in an off-operation, in which the high-voltage power source HV of the battery supplied to the PTC heater 200 is blocked, and supplies the output voltage to the PTC heater 200.

Accordingly, the heating operation may be continuously generated in the PTC heater 200 regardless of on/off of the PWM signal.

The switch 103 is formed of a semiconductor switch device for a high voltage, and may adopt any one of a field effect transistor (FET), a metal oxide semiconductor field effect transistor (MOSFET), and an insulated gate bipolar transistor (IGBT).

When it is assumed that the switch 103 adopts the FET, the high voltage power source HV is connected to a source terminal S, the PWM signal of the controller 102 is connected to a gate terminal G, and a drain terminal D is connected to the ground.

The source terminal S and the drain terminal D of the switch 103 are connected with the charger 104 and the PTC heater 200 in parallel.

The charger 104 charges a voltage according to a control signal of the controller 102 when the switch 103 is turned on, and the high voltage power source HV of the battery is electrically conducted. The charger 104 prevents an unnecessary overvoltage from being supplied to the PTC heater 200 and permanently supplies a stable voltage to the PTC heater 200.

That is, the PTC heater 200 uses an unnecessary power source as a charging power source when the switch 103 is turned on, and the high-voltage power source HV of the battery is supplied to the PTC heater 200, so that the charger 104 may maintain the stable supply of the power source to the PTC heater 200.

The charger 104 discharges the charged voltage according to the control signal of the controller 102 when the switch 103 is turned off and supplies the voltage to the PTC heater 200.

Accordingly, the PTC heater 200 is operated with the power source supplied from the charger 104 even in a state where the high-voltage power source HV of the battery is not supplied, to perform a heating operation.

An operation of the present disclosure including the aforementioned functions will be described below.

In a state where heating is on standby during travelling of the environmentally-friendly vehicle (S101), to which the present disclosure is applied, the controller 102 determines whether a heating demand and temperature setting are input from the signal input 101 (S102).

When the heating demand is input in step S102, the controller 102 determines a target temperature for heating with the PTC heater 200 according to a temperature setting condition (S103), and calculates the quantity of power supplied to the PTC heater 200 according to the target temperature (S104).

When the quantity of power supplied to the PTC heater 200 is calculated in step S104, the controller 102 determines a duty cycle (%) of the PWM signal for controlling on/off of the switch 103 according to the calculated quantity of power.

Further, the controller 102 determines the quantity of charge of the charger 104 according to the quantity of power supplied to the PTC heater 200 in step S104.

When the duty cycle (%) of the PWM signal is determined according to the quantity of power supplied to the PTC heater 200, and the quantity of charge of the charging unit 104 is determined, the controller 102 outputs the PWM signal with the determined duty cycle (%) to turn on/off the switch 103, and controls a charging/discharging operation of the charging unit 104 at the same time (S107).

When the switch 103 is turned on by the PWM signal output from the controller 102, a power line, such as \textcircled{1}, is formed, so that the high-voltage power source HV of the battery is supplied to the PTC heater 200, and thus, the PTC heater 200 emits heat.

In this case, the high-voltage power source HV is also equally supplied to the charger 104, which is connected with the PTC heater 200 in parallel, so that the charging operation is performed under the control of the controller 102.

When the controller 102 controls the quantity of charge charged in the charger 104, the power source unnecessarily supplied to the PTC heater 200 is used as the charging power source.

Accordingly, the stable power source is permanently supplied to the PTC heater 200, thereby preventing unnecessary power consumption from being generated, and preventing overheat from being generated due to supply of an overvoltage.

Further, when the switch 103 is turned off by the PWM signal output from the controller 102, the high-voltage power source HV of the battery supplied to the PTC heater 200 is blocked, so that the controller 102 discharges the power source discharged in the charger 104 and supplies the discharged power source to the PTC heater 200 to form a power line, such as \textcircled{2} in FIG. 1.

Accordingly, the supply of the power source from the charger 104 to the PTC heater 200 is maintained in a state where the high-voltage power source HV of the battery is not supplied, so that the heating operation of the PTC heater 200 is maintained as it is.

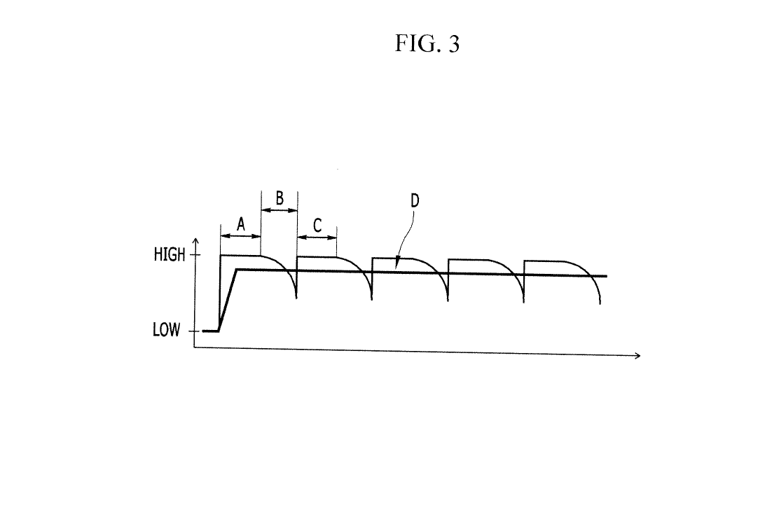

In the above operation, as can be seen in FIG. 3, when the switch 103 is turned on by the PWM signal output from the controller 102, power sources “A” and “C” are supplied to the PTC heater 200. When the switch 103 is turned off by the PWM signal, the power charged in the charger 104 is discharged and supplied to the PTC heater 200 as the power source, and the discharge voltage is gradually decreased, so that a power source, such as “B”, is supplied to the PTC heater 200.

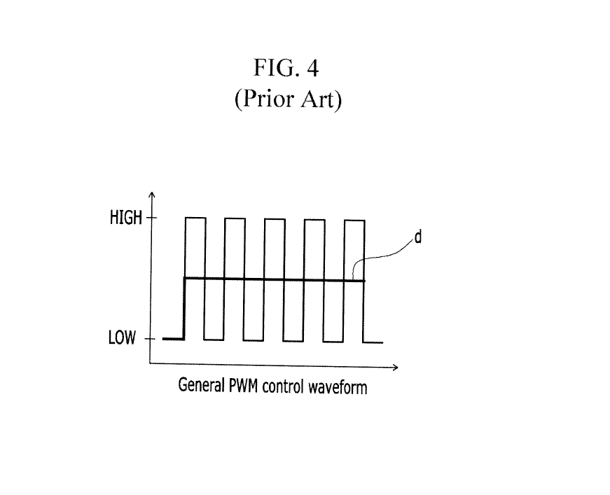

As mentioned in the related art, compared to a duty cycle of a general PWM signal output as illustrated in FIG. 4, when the same frequency and duty cycle are supplied, an average voltage applied to the PTC heater 200 is high like “D”.

Accordingly, in a case where the PTC heater 200 is controlled by adopting the aforementioned method, even though a frequency is set to be lower than a frequency of a general PWM signal, there is an effect in that the same or higher voltage is applied to the PTC heater 200, thereby decreasing noise.

Further, when the PTC heater 200 is controlled in the same frequency as the frequency of the general PWM signal, the same effect may be achieved with a low power.

The controller 102 measures a temperature of heat of the PTC heater 200 in a state where the power source is supplied to the PTC heater 200 according to the aforementioned procedure for the PTC heater 200 to emit heat (S108), and determines whether the measured temperature of the heat of the PTC heater 200 reaches the target temperature set in step S103 (S109).

When the measured temperature of the heat of the PTC heater 200 does not reach the target temperature in the determination of step S109, the method returns to step S105, and when the measured temperature of the heat of the PTC heater 200 reaches the target temperature, the controller 102 maintains the current duty cycle of the PWM signal (S110).

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for controlling a heater of an environmentally-friendly vehicle, the system comprising:
a signal input configured to input a heating demand and a temperature setting signal of a driver;
a positive temperature coefficient (PTC) heater which is a heat source for heating;
a controller configured to determine a target temperature according to the heating demand, determine a quantity of power supplied to the PTC heater, and determine a duty cycle of a pulse width modulation (PWM) signal;
a switch controlled according to a PWM signal of the controller to operate the PTC heater; and
a charger which is charged/discharged when the switch is turned on/off according to the PWM signal of the controller to protect the PTC heater.

2. The system of claim 1, wherein
the PTC heater and the charger are connected to a high-voltage power line in parallel.

3. The system of claim 1, wherein
the controller determines a quantity of charge of the charger according to the quantity of power supplied to the PTC heater and controls the charge of the charger.

4. The system of claim 1, wherein
the controller variably sets a quantity of charge of the charger according to the target temperature and the quantity of heat of the PTC heater, and the quantity of power supplied to the PTC heater.

5. The system of claim 1, wherein
the charger is charged with a high-voltage power source of a battery supplied to the PTC heater when the switch is turned on according to a control signal of the controller, and supplies the charged voltage to the PTC heater when the switch is turned off, and the high-voltage power source of the battery supplied to the PTC heater is blocked.

6. The system of claim 1, wherein
when the switch is turned on, the charger blocks supply of an overvoltage to the PTC heater to prevent heat from being lost.

7. A method of controlling a heater of an environmentally-friendly vehicle, the method comprising steps of:
determining a target temperature of a PTC heater when a heating demand of a driver is detected, and calculating a quantity of power supplied to the FTC heater according to the target temperature;
determining a duty cycle of a PWM signal according to the quantity of power supplied to the PTC heater;
determining the quantity of charge charged in a charger, which is connected to the PTC heater in parallel, according to the quantity of power supplied to the PTC heater; and
operating the PTC heater by controlling turning on/off a switch in response to an output of the PWM signal, and controlling charge/discharge of the charger, which is connected to the PTC heater in parallel.

8. The method of claim 7, wherein:
when the switch is turned on with the output of the PWM signal, the charger is charged with a power source supplied to the PTC heater to prevent an overvoltage from being supplied to the PTC heater.

9. The method of claim 7, wherein:
when the switch is turned off with the output of the PWM signal, a voltage charged in the charger is supplied to the PTC heater to maintain an operation of the PTC heater even in a state where a high-voltage power source is blocked.

10. A system for controlling a heater of an environmentally-friendly vehicle, the system comprising:
a signal input configured to detect a heating demand of a driver;
a controller configured to determine a target temperature according to the heating demand, and determine a quantity of power of a heating body;
a switch configured to control a power source supplied to the heating body according to a PWM signal of the controller; and
a charger connected to the heating body in parallel to execute charging/discharging according to an on/off operation of the switch.
